(19) United States
(12) Patent Application Publication
(10) Pub. No.: US 2025/0124513 A1
(43) Pub. Date: Apr. 17, 2025

(54) ASSESSMENT TOOL, GRAPHICAL USER INTERFACE, AND ASSOCIATED FUNCTIONALITY

(71) Applicant: Nearmap Australia Pty Ltd., Barangaroo (AU)

(72) Inventors: Aaron David ROOT, Sydney (AU); Panna CHERUKURI, Wentworthville (AU); Han-Jhih JIANG, Sydney (AU); Michael BEWLEY, West Pymble (AU); Lodewicus Jacobus BRINK, Leura (AU); Zoran STOJAKOVIC, Sydney (AU); Nagita Mehr SERESHT, Sydney (AU); Brett TULLY, Sydney (AU); Kitty LO, Oatley (AU); Arihant SURANA, Sydney (AU); Lee DENNIS, Blacktown (AU)

(73) Assignee: Nearmap Australia Pty Ltd., Barangaroo (AU)

(21) Appl. No.: 18/797,590

(22) Filed: Aug. 8, 2024

Related U.S. Application Data
(60) Provisional application No. 63/544,262, filed on Oct. 16, 2023.

(51) Int. Cl. G06Q 40/08; G06Q 50/16

(52) U.S. Cl. CPC G06Q 40/08; G06Q 50/16

(57) ABSTRACT

A property assessment system includes circuitry that obtains predetermined data for one or more properties, and obtains at least one of a map or an image of the one or more properties. The circuitry then generates assessments for the one or more properties based on the predetermined data, and ranks the one or more properties based on the assessments. The circuitry generates a list of the one or more properties based on the rank, and displays the list of the one or more properties in conjunction with the map or image of the one or more properties.

### CROSS-REFERENCE TO RELATED APPLICATION

This application claims the benefit of priority to U.S. provisional application No. 63/544,262, filed Oct. 16, 2023, the entire contents of which are hereby incorporated by reference.

### BACKGROUND

### Technical Field

The present disclosure relates to a graphical user interface and associated functionality, and more specifically for a graphical user interface and associated functionality for analysis of structures and surrounding environments thereof.

### Discussion Of Background

Insurance assessments of properties, such as houses, buildings, and other structures requires analysis of an array of different factors, some of which are time-varying, and most of which must be aggregated from different sources. Even with the advent of aerial imaging of the properties, which can eliminate site visits, and computerized tools, insurance assessment remains a tedious, time consuming process of data aggregation and analysis. Assessment can be made even more laborious by the occurrence of a catastrophic event, such as fire damage, storm damage, flood, etc., due to the additional requirements of damage assessment and post-event action determination. It can further be complicated by other events such as the construction or repair of aspects of the property such as the roof, or changes to the environment around the property such as the growth or removal of vegetation or deterioration of aspects of the property.

Thus, a need exists for an assessment tool that can synthesize and present information on a property in a streamlined, easy to understand way to allow an assessor to quickly understand the condition of the property and surrounding environment in order to efficiently perform an insurance assessment and/or post-event action determination.

### SUMMARY

According to an exemplary aspect of the disclosure, a property assessment system includes circuitry that obtains predetermined data for one or more properties, and obtains at least one of a map or an image of the one or more properties. The circuitry then generates assessments for the one or more properties based on the predetermined data, and ranks the one or more properties based on the assessments. The circuitry generates a list of the one or more properties based on the rank, and displays the list of the one or more properties in conjunction with the map or image of the one or more properties.

According to an exemplary aspect of the present disclosure, a property assessment method performed is by circuitry of a property assessment system. The method includes obtaining predetermined data for one or more properties, and obtaining at least one of a map or an image of the one or more properties. Then the method generates assessments for the one or more properties based on the predetermined data, and ranks the one or more properties based on the assessments. A list of the one or more properties in then generated based on the rank, and the list of the one or more properties is displayed in conjunction with the map or image of the one or more properties.

According to an exemplary aspect of the present disclosure, a non-transitory computer-readable medium is encoded with computer-readable instructions that, when executed by processing circuitry, cause the processing circuitry to perform a method. The method includes obtaining predetermined data for one or more properties, and obtaining at least one of a map or an image of the one or more properties. The method also includes generating assessments for the one or more properties based on the predetermined data, and ranking the one or more properties based on the assessments. A list of the one or more properties in then generated based on the rank, and the list of the one or more properties is displayed in conjunction with the map or image of the one or more properties.

### BRIEF DESCRIPTION OF THE DRAWINGS

A more complete appreciation of the disclosure and many of the attendant advantages thereof will be readily obtained as the same becomes better understood by reference to the following detailed description when considered in connection with the accompanying drawings, wherein:

FIG. 1 is a graphical user interface of a property list view of the assessment tool according to exemplary aspects of the present disclosure;

FIG. 2 is a graphical user interface of another property list view of the assessment tool according to exemplary aspects of the present disclosure;

FIG. 3 is a graphical user interface of a property view of the assessment tool according to exemplary aspects of the present disclosure;

FIG. 4 is a graphical user interface of another property view of the assessment tool according to exemplary aspects of the present disclosure;

FIG. 5 is a graphical user interface of an impact response survey of the assessment tool according to exemplary aspects of the present disclosure;

FIG. 6 is a graphical user interface of another impact response survey of the assessment tool according to exemplary aspects of the present disclosure;

FIG. 7 is an example of the time line format and an exemplary timeline used in both property views and an impact response surveys according to exemplary aspects of the present disclosure;

FIG. 8 is a graphical user interface of predictive property data in a property view of the assessment tool according to exemplary aspects of the present disclosure;

FIG. 9 is a graphical user interface of a property view of the assessment tool with inferred events according to exemplary aspects of the present disclosure;

FIG. 10 is a graphical user interface of an impact response survey of the assessment tool including third-party data according to exemplary aspects of the present disclosure;

FIG. 11 is a graphical user interface during in-flight processing by the assessment tool according to exemplary aspects of the present disclosure;

FIG. 12 is another graphical user interface of in-flight processing by the assessment tool according to exemplary aspects of the present disclosure;

FIG. 13 is a photograph of capturing property data during a site visit according to exemplary aspects of the present disclosure;

FIG. 14 is a graphical user interface of a property view of the assessment tool in which the site visit property data captured in FIG. 13 is integrated according to exemplary aspects of the present disclosure;

FIG. 15 illustrates reinforcement learning by the assessment tool according to exemplary aspects of the present disclosure;

FIG. 16 illustrates AI generated property content according to exemplary aspects of the present disclosure;

FIG. 17 illustrates end-user information generated using the assessment tool according to exemplary aspects of the present disclosure;

FIG. 18 is an algorithmic flow chart of assembling property lists and selecting properties according to exemplary aspects of the present disclosure;

FIG. 19 is an algorithmic flow chart of collecting property list data according to exemplary aspects of the present disclosure;

FIG. 20 is an algorithmic flow chart of displaying a property list according to exemplary aspects of the present disclosure;

FIG. 21 is an algorithmic flow chart of generating and displaying a timeline for a property according to exemplary aspects of the present disclosure;

FIG. 22 is an algorithmic flow chart of displaying a property view according to exemplary aspects of the present disclosure;

FIG. 23 is an algorithmic flow chart of generating predictive events according to exemplary aspects of the present disclosure;

FIG. 24 is an algorithmic flow chart of generating inferred events according to exemplary aspects of the present disclosure;

FIG. 25 is an algorithmic flow chart of in-flight processing according to exemplary aspects of the present disclosure;

FIG. 26 is an example of processing aerial imagery according to exemplary aspects of the present disclosure;

FIG. 27 is an example processing flow for machine learning feature classification according to exemplary aspects of the present disclosure;

FIG. 28 is a schematic drawing of a processing system according to exemplary aspects of the present disclosure.

### DETAILED DESCRIPTION

As used herein, an element or step recited in the singular and proceeded with the word “a” or “an” should be understood as not excluding plural elements or steps, unless such exclusion is explicitly recited. Furthermore, references to “one embodiment” of the present disclosure are not intended to be interpreted as excluding the existence of additional embodiments that also incorporate the recited features.

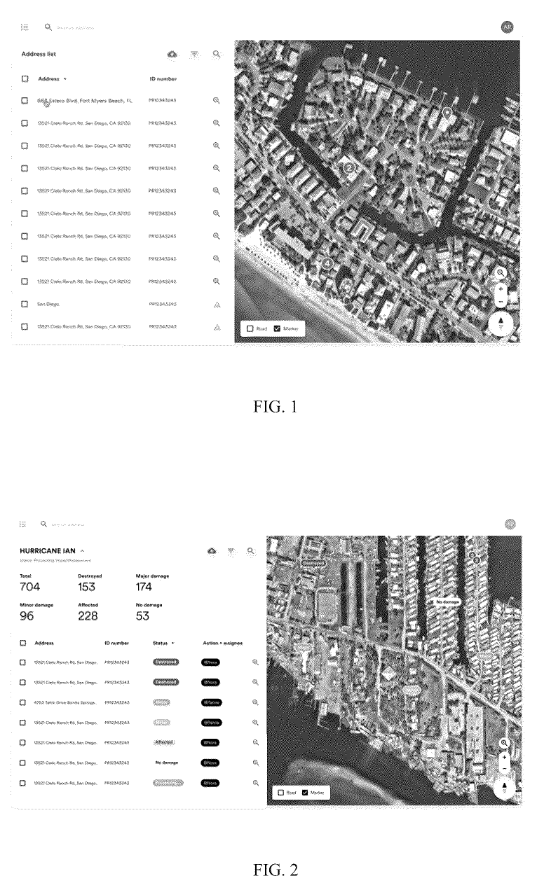

FIG. 1 is a graphical user interface (GUI) of a property list according to exemplary aspects of the present disclosure. The property list includes an aerial image of a geographical are including a plurality of properties and a list of the properties (and their corresponding ID numbers) included in the aerial image. A search bar provides the ability to search for a particular property by address. The list of properties also includes several tools, such as an upload/share tool to upload/share the property list to another service, a mobile application, cloud storage and the like; a search tool to search within the displayed list of properties; and a filter/sort tool to filter and/or sort the displayed list of properties according to predetermined criteria. For example, a user may upload a set of properties to the property list view based on (a) a portfolio of insurance customers in a local region, (b) a set of properties known to have been affected by an event such as a hurricane, (c) a set of properties known to have an elevated risk to an event such as wildfire, and so forth.

The aerial image displayed in the GUI of FIG. 1 is interactive in that it may be zoomed in, zoomed out, panned in any direction, and/or rotated. The list of properties is continually updated as the aerial image is zoomed and/or panned in order to reflect the properties displayed in the aerial image as the image is manipulated. The number of properties in the list of properties may also differ according to the zoom level of the aerial image. For example, if the zoom level is increased so that the aerial image includes fewer properties at a larger magnification level, the list of properties is updated to include the fewer properties. If the zoom level is decreased to, for example, encompass an entire housing development, the list of properties is updated to include a larger number of properties, namely all of the properties in the housing development.

The list of properties may also be changed/updated by searching for a particular address using the search bar. The result may be a list of properties including the property searched for and surrounding properties. For example, if the aerial image is set at a zoom level that encompasses an entire housing development, a search via the search bar for an address of a property within the housing development results in inclusion of all of the properties of the development in the list of properties. Conversely, if the zoom level of the aerial image is such that only a few properties are visible, for example, five properties, the search bar results will include only the searched for property and four other properties which are visible in the aerial image.

The aerial image may also be updated to reflect the results of a search via the search bar. For example, the aerial image may be updated to display the searched for property at its center. Moreover, if as part of the search criteria, a specific number of properties are requested, a zoom level of the aerial image may be changed in order to display the specific number of properties.

As can be appreciated, the number of properties in the property list may be large. Therefore, to allow for efficient workflow, the property list itself may be searched using a search tool defined by the loupe at the top right corner of the property list. This search tool allows for quick identification of a particular property via its address, property ID number, plot number, plat number, etc. The result of this search is the single property searched for, but additional properties may also be included in the result based on user search criteria as one of ordinary skill would recognize.

To identify a range of properties that fit predetermined criteria, the list of properties includes a filter/sort tool whose icon is shown next to the search tool. The results of the filter/sort tool is display of only those properties matching the predetermined criteria to a specified threshold. For example, the result may be the properties with a matching score of 90% or higher. As can be appreciated, the specified threshold may be settable by the user, and the results may ordered in terms of matching score.

As can be appreciated, the search results, whether obtained via the search bar or the search tool can be displayed in place of the list of properties shown in FIG. 1, or can be displayed in a separate window, such as a pop-up window overlayed on at least a portion of the list of properties, at least a portion of the aerial image, or both. Moreover, the layout of the property list view shown in FIG. 1 may be altered so that the aerial image and the list of properties are displayed top and bottom rather than side to side, the positions of the list of properties and the aerial image may be swapped, or the list of properties and the aerial image may be displayed in separate windows, which, for example, may be floating windows that may overlap each other and/or any other window that is open. Accordingly, the precise layout of the aerial image and list of properties illustrated in the GUI of FIG. 1 is not limiting upon the present disclosure.

FIG. 2 illustrates a GUI displaying another property list view according to exemplary aspects of the present disclosure. The functionalities of the search bar, search tool, filter/sort tool, and upload/share tool are substantially similar to those described above with respect to FIG. 1 and are therefore not repeated for the sake of brevity. The property list view of FIG. 2 is used to perform a post-event assessment of, for example, insured properties after the occurrence of a damaging event, such as a weather event, fire, earthquake, flood, etc. As such, the property list view of FIG. 2 is termed an “Impact Triage” view.

In the example of FIG. 2, a property list view is displayed on the GUI that includes a list of properties and an aerial image, similar to that displayed in FIG. 1. However, the list of properties in FIG. 2 and the aerial image corresponding to properties after the passage of a hurricane. Thus, the list of properties in FIG. 2 includes additional columns of information, such as the status of each property ranging from “destroyed” to “no damage,” and the action/assignee column indicating what action is to be taken for a property and who is assigned to carry out the action.

As can be appreciated, the list of properties in FIG. 2 may be arranged in order of address, amount of damage, value, action to be taken, person assigned to each action, and the like. The list of properties can also be filtered based on these criteria, and others, to display only those properties that meet the criteria and/or at least have a matching score above a certain threshold.

The Impact Triage view also includes a section above the list of property which provides totals for various metrics such as, for example, total number of properties, the number of properties destroyed, the number of properties with major damage, the number of properties with minor damage, the number of properties affected in some way, total estimated cost associated with the damage, and the number of properties with no damage. Of course, other metrics may be included in this section without limitation as one of ordinary skill will recognize.

The aerial image in FIG. 2 also includes indications of the damage levels of the displayed properties. For example, the aerial image includes markers indicating destroyed, major damage, minor damage, and no damage. The markers may correspond to specific properties or may correspond to an area that encompasses a plurality of properties. For example, at a given zoom level, the aerial image may display a status marker for each displayed property, and as the zoom level decreases (e.g., by zooming out) the status markers may transition to one status marker for several properties, one status marker per area or the like. If the status marker corresponds to multiple properties, the status marker displays the predominant damage level of the multiple properties. For example, only one property has no damage and all other properties in a given area have major damage, the status marker for the given area may be “major.” Other variations are possible without departing from the scope of the present disclosure.

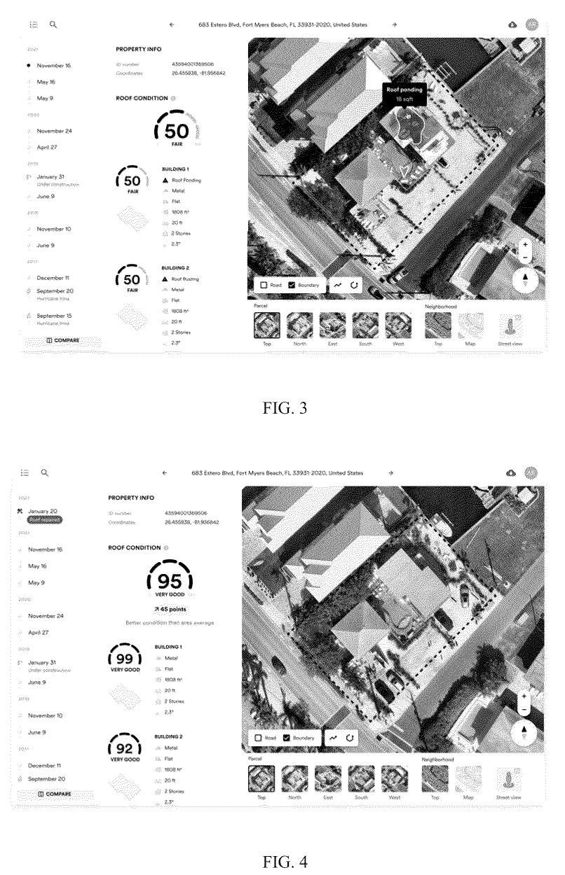

The list of properties in the property views of FIGS. 1-2 include a loupe icon for each listed property. Selecting this loupe icon brings up a property view for the chosen property as is described below with reference to FIGS. 3-4.

FIG. 3 is a GUI display of a property view according to exemplary aspects of the present disclosure. The property view includes an aerial image of the property which may also include an indication of the boundaries of the property and other property features, such as roof ponding, as discussed in more detail below. The aerial image may also display adjacent properties or may be such that only the property in question is displayed. As shown in FIG. 3, the property may include multiple structures, and a navigation section below the aerial image may provide different views of the property, including a map view and street view.

The property view also includes a property information area that displays information such as property ID number and geographic coordinates, for example, expressed as latitude and longitude. Condition assessments of the different structures on the property are also included. For example, the roof condition of each building on the property may be displayed, as well as an overall roof condition. The roof condition may be determined on a number of factors such as roofing material, roof style, pitch, age, wear, damage, etc. A reason for the roof condition may also be given, such as roof ponding (where water collects in an area of the roof and does not drain) or rusting. Other information, such as the number of stories of each building and building dimensions may also be provided, as one of ordinary skill would recognize.

The property view of FIG. 3 also includes a timeline of events for the property in question. For example, the time line in FIG. 3 includes events including hurricanes on September 15 and 20 of 2016 and construction on Jan. 31, 2018. Selecting any of the events and/or dates displayed on the timeline causes the property view to display an aerial image of the property and property data corresponding to the property on the selected date. Thus, a user is able to see the progression of property condition through the span of time on the time line.

FIG. 4 is a GUI displaying the same property as FIG. 3, but highlighting recent events concerning the property. For example, in FIG. 4 the roof is highlighted on the timeline as having been repaired on Jan. 20, 2020. The roof conditions for each building on the property, and the overall roof condition, reflects the repairs as increased scores. Also, the highlighting of the ponding on the roof that was present in FIG. 3 has now been removed providing further indication that the problem has been resolved.

FIG. 5 is a GUI displaying a property view for post-event assessment according to exemplary aspects of the present disclosure. In FIG. 5, the property has experienced a hurricane, Hurricane Ian, on Sep. 28, 2021. The property information section indicates the corresponding damage due to the storm, the debris caused by the storm, and the current building condition. In some cases, pre-existing damage may have been present at the property prior to the event, in which case that is noted and displayed.

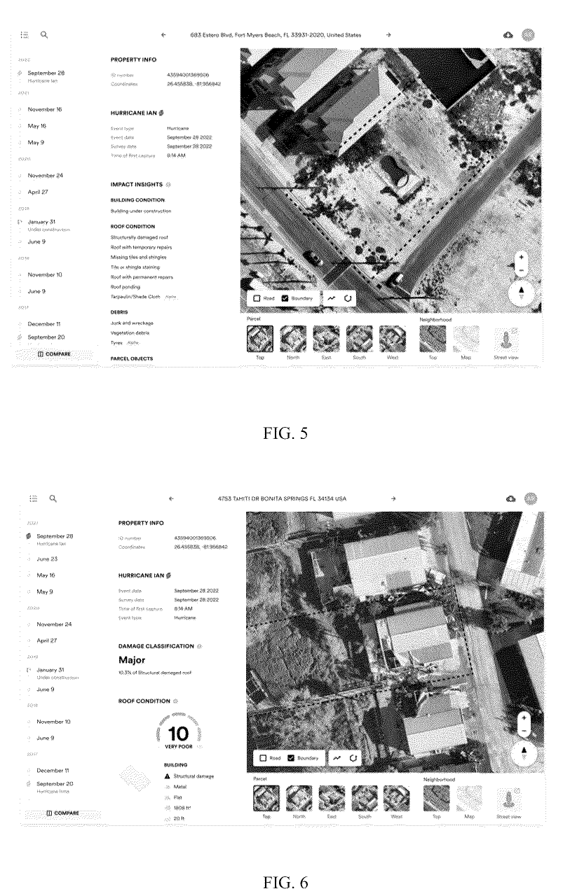

FIG. 6 is a GUI displaying another property view for post-event assessment that is either an alternative to the view of FIG. 5 or in addition to the view of FIG. 5. As with the other property views in FIGS. 3-5, FIG. 6 includes an aerial image, property information section, and timeline. However, the property information section of FIG. 6 includes damage classifications and condition scores to aid in the rapid assessment of the property. For example, the damage classification of the property is identified as “Major” with 10.3% of it being structural roof damage. A corresponding roof condition score of 10, or “very poor” is also shown along with the reason(s) for the score (structural damage). As can be appreciated, other aspects of the property condition may be included in the property view of FIG. 6. For example, the condition of the building walls, windows, flood damage, etc., may also be reflected in corresponding condition scores and taken into account in the damage classification. The condition of the roof or other aspects of the property may be presented relative to neighboring properties or an average of neighboring properties. Thus, the specific example illustrated in FIG. 6, and those of FIGS. 3-5 as well, are merely exemplary and not limiting upon the present disclosure.

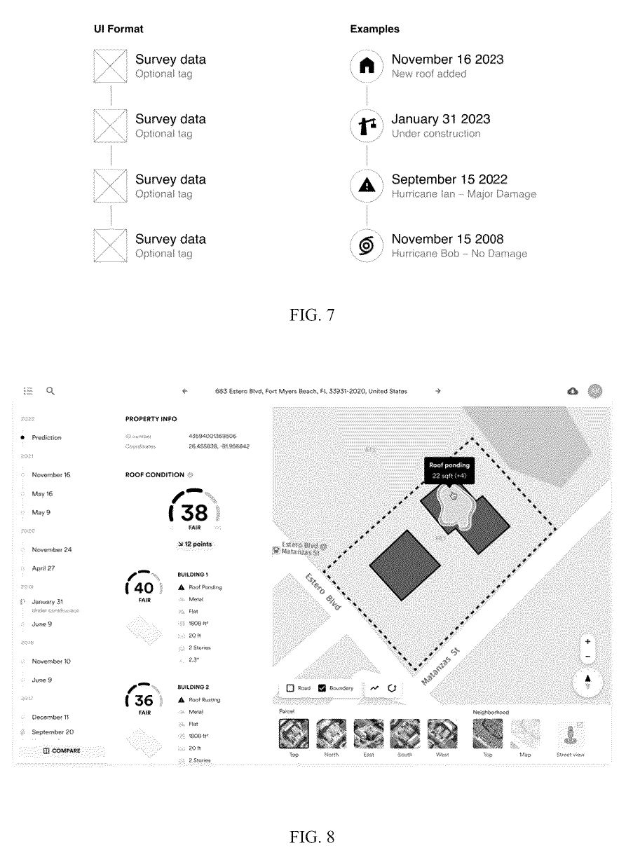

FIG. 7 illustrates examples of entries in a timeline, such as the timelines of FIGS. 3-6. For example, entries on the timeline for dates on which surveys of the property were made may be displayed on the timeline as survey data (left side of FIG. 7), and entries corresponding to significant events may be entered on the timeline as shown as illustrated in the right side of FIG. 7. Corresponding icons and/or other graphics may be displayed in conjunction with a small description, or label, for the entry. As noted above, selecting any one of these entries results in a property view with data from the entry.

FIGS. 3-7 illustrate property views generated based on current and past data. FIG. 8 is a GUI displaying a predictive property view of future property conditions. For example, the timeline in FIG. 8 includes a “prediction” between 2021 and 2022, and the corresponding prediction of building and roof condition are also displayed. To determine the predicted, future condition, the assessment tool extrapolates from the past and current data. Here, the roof condition is predicted to deteriorate to a “fair” condition due to continued/increasing roof ponding. A corresponding drop in the overall building condition is also reflected in the predictive property view. As described above with reference to the other property views, roof condition is only one example metric and conditions of other aspects of the building(s) on the property may also be determined and displayed, as one of ordinary skill would recognize.

The predictive property view of FIG. 8 also includes an aerial representation of the property. However, as illustrated the representation is in the form of a map view rather than an image. The map view includes an indication of the boundaries of the property, the building(s) within the property and the roof ponding. Progression of the roof ponding can also be reflected by concentric/expanding areas encompassing the ponding on the roof. A marker may also indicate the roof ponding position, the area affected, and the increase in the area. For example, in FIG. 8 the marker indicates that the roof ponding has increased by 4 ft² to a total area of 22 ft².

Though the aerial representation of the property is presented in map form in FIG. 8, it is also possible to access other views of the property, such as top, north, east, south, and west representations. These representations may be of past images of the property or may be a computer-generated representation similar to the illustrated map view.

Moreover, the predictive property view of FIG. 8 may be accessed via the timeline by, for example, selecting the “prediction” as noted above. This allows for a seamless transition between the property views of current/past data (e.g., those of FIGS. 3-7) and the predictive property view of FIG. 8. Of course, the predictive property view of FIG. 8 may also be accessed by a separate control/button/icon added to one of the property views of FIGS. 3-7 and/or to the property list views of FIGS. 1-2.

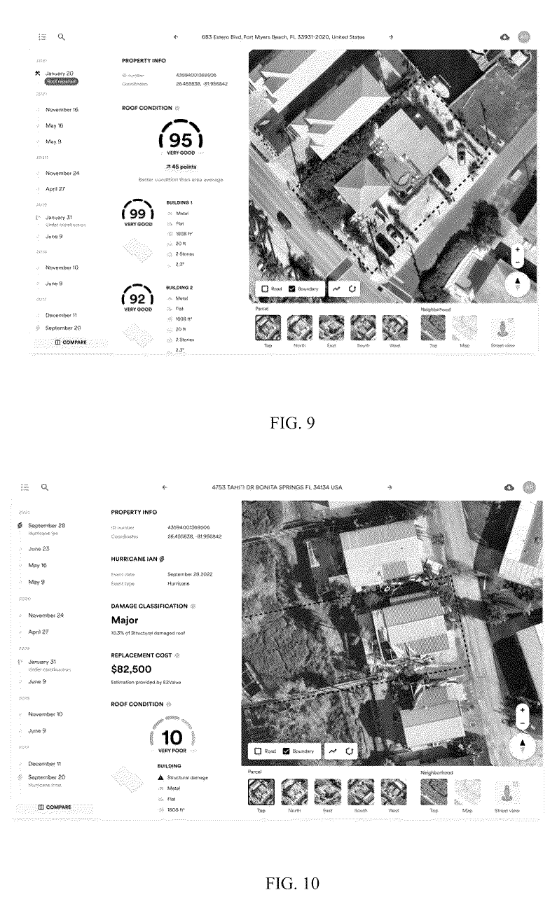

FIG. 9 is a GUI of another property view that includes inferred information. The aerial image in the property view of FIG. 9 shows that the roof of the building on the property that had ponding in FIG. 3 no longer has ponding. Therefore, the assessment tool infers that the roof was fixed, and reflects this through an entry on the time line on Jan. 20, 2020, indicating that the roof was repaired. The repair is also reflected in the improved roof condition and building scores.

The assessment tool may infer information, such as performance of repairs, increased deterioration, damage, etc., via image analysis of successive aerial images of the property obtained over time. The assessment tool may also use artificial intelligence (AI) in order to generate the inferred information, for example. Other information may also be used, for example, information disclosures from property owners, such as certificates of building words, etc.

FIG. 10 is a GUI displaying another property view according to exemplary aspects of the present disclosure. The property view of FIG. 10 includes substantially similar information and imagery as discussed above with reference to FIGS. 3-9. In addition, FIG. 10 also includes third-party information such as a repair cost estimate obtained from a third-party vendor. For example, in FIG. 10, replacement of the roof of the building situated on the property is estimated to cost $82,500. Of course, this is just one example of third-party data that can be obtained and displayed in a property view according to exemplary aspects of the disclosure. Other data, such repair time estimates, zoning and permitting information, flood zone information, property tax, millage rates, and the like, may also be displayed.

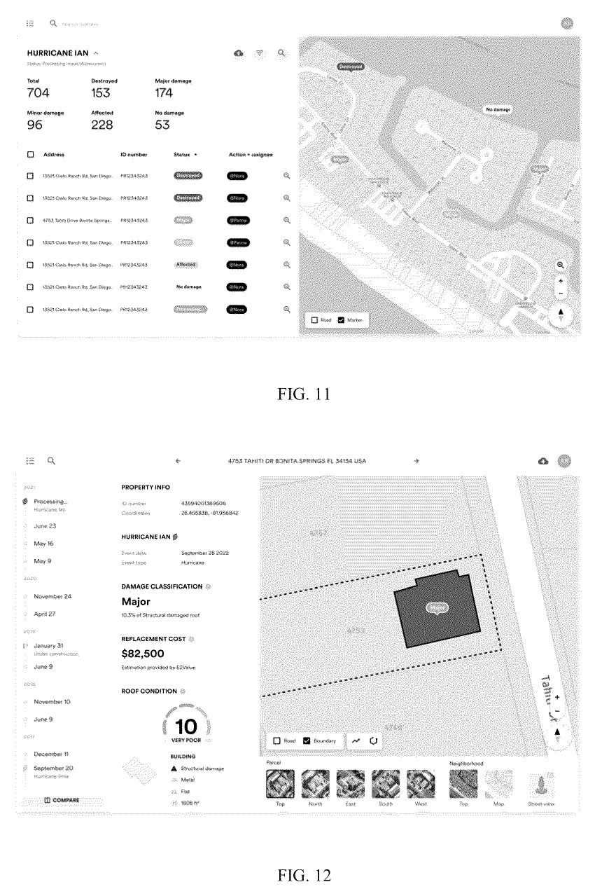

FIGS. 11-12 illustrate respective “in-flight” property list and property views according to exemplary aspects of the present disclosure. In-flight views are displayed as data for the views is still being obtained and/or generated and/or using live data. For example, in FIG. 11 the last entry in the list of properties is still being processed as reflected by its status. The aerial view of FIG. 11 is also a map view since the aerial image has not yet been obtained and/or is in the process of being obtained and prepared for display. FIG. 12 is a property view that indicates that the data and assessment for Hurricane Ian is still being processed. The data is partially available as seen in the present results. However, for example, the imagery may not yet be available and so pre-existing vector map data is displayed. As and when the image data is available, the property view may update to replace the vector map data with image data. As with FIG. 11, the aerial depiction of the property is in map form since aerial imagery of the affected property/area may not yet be available. The in-flight property list view and property view of FIGS. 11-12 allow for rapid assessment of properties after events such as hurricanes, floods, earthquakes, and other natural (or manmade) disasters.

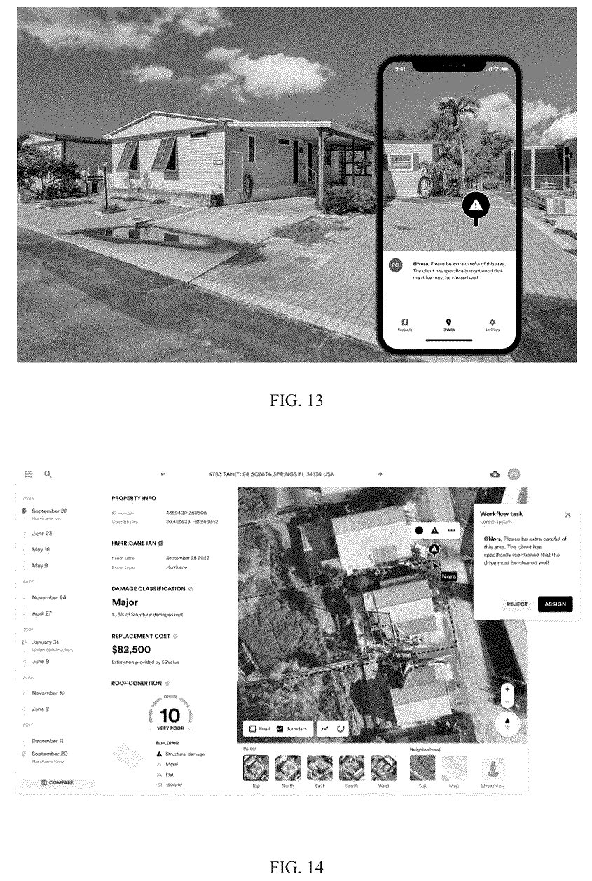

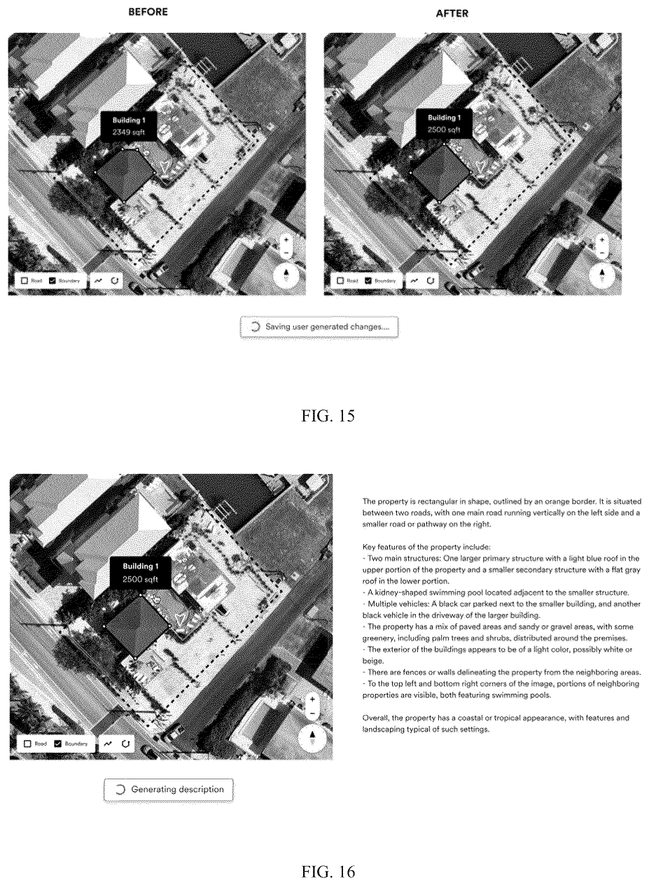

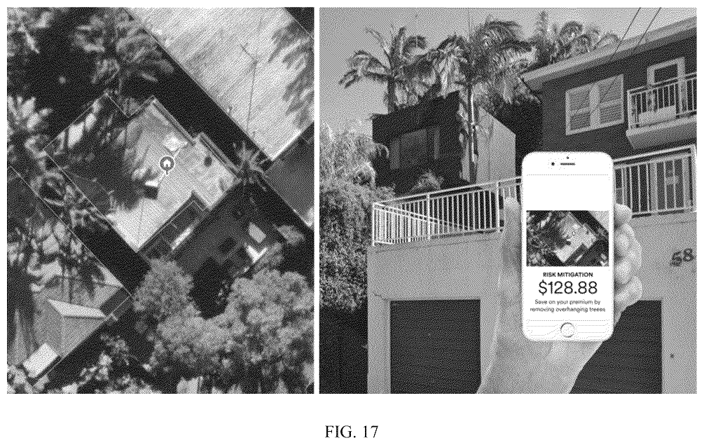

FIGS. 13-14 illustrate integration of on-site data into the assessment tool according to exemplary aspects of the present disclosure. For example, an agent may visit a property and, for example, capture an image of an aspect of the property. The image may then be communicated to the assessment tool along with notes corresponding to the image. In the example of FIG. 13, an image of the driveway of the property is captured and a note that the area must be cleared is appended to the image. As illustrated in FIG. 13, the image includes a marker highlighting the area of the property corresponding to the note.

The marker of FIG. 13 then appears in the aerial image of the property displayed in the property view of FIG. 14. Selecting the marker in the aerial image causes a pop-up window to be displayed in order to present the note added by the on-site agent. The pop-up window also includes a button for assigning the note/action item or to reject the note/action item. As can be appreciated several such notes/action items may be captured by the on-site agent and corresponding markers may be displayed in the aerial image of the property view of FIG. 14. This allows for the identification and assignment of tasks that may not be apparent through aerial image surveys alone.

FIG. 15 illustrates reinforcement learning by the assessment tool according to exemplary aspects of the present disclosure. FIG. 15 includes a before and an after image. In the before image, the tool has not correctly and/or completely identified the roof of building 1. Therefore, the area of the roof of building 1 has been incorrectly computed as 2349 ft². This can be manually corrected via user interaction with the tool by modifying the frame encompassing the roof of building 1 to include the upper corner as shown in the after image. Thus, the roof area is correctly shown as 2500 ft². Moreover, the assessment tool learns the proper bounds of the roof based on the user correction in order to improve its identification of the roof in future imagery of the building.

In addition to the property list and property views discussed above, the assessment tool may also generate descriptive content for a property, such as a description of the property lot and the structures on the property as illustrated in FIG. 16. This descriptive content may be generated using machine learning, generative AI, and the like, and may be accompanied by an image of the property, such as the one illustrated in FIG. 16. The assessment tool, and/or the AI components thereof, may use the property data discussed above with response to the property list and the property view in order to generate the descriptive content, for example. The descriptive content may then be manually edited, as one of ordinary skill would recognize.

FIG. 17 illustrates the deliverable to an end-user, which may be the owner of a property. As illustrated in FIG. 17, the end-user is provided an estimate of potential insurance premium savings and the task that needs to be performed in order to receive the savings. For example, in FIG. 17, the end user is provided with a $128.88 savings potential if they remove overhanging trees from the property. The estimate is generated using, for example, the assessment tool described herein. As can be appreciated, the manner in which the insurance premium savings estimate is provided to the end-user is not limiting upon the present disclosure. In the case of FIG. 17, the end-user receives the estimate via an app on a mobile device. However, the end-user may also receive the estimate via email, regular mail, website portal, and the like.

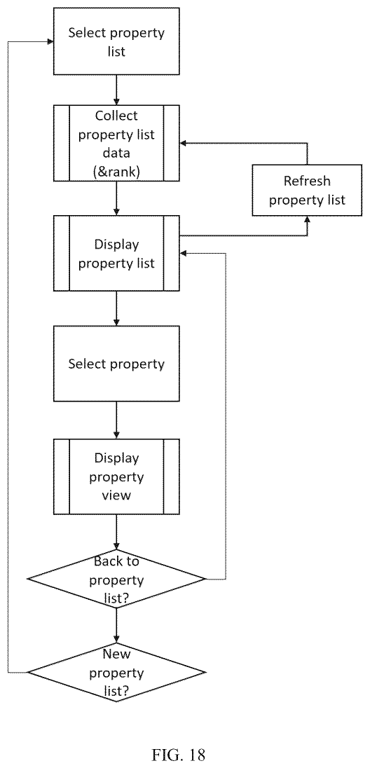

Next the processing performed by the assessment tool, and the underlying hardware, is described with respect to FIGS. 18-27.

FIG. 18 is an algorithmic flow chart of the overall process flow of the assessment tool according to exemplary aspects of the present disclosure. Thus, FIG. 18 provides an overview of the processing required to generate the product list views of, for example, FIGS. 1-2 and the property views of, for example, FIGS. 3-10. The process begins with selection of a property list which may be a comma-separated-value (CSV) list stored in a database or manually entered via a GUI. The property list may also be in formats other than CSV, such as SQL formats, for example. Thus, the format in which the property list data is stored is not limiting upon the present disclosure.

After obtaining the property list, property list data is collected and ranked as will be described in greater detail below. Then the property list is displayed as explained above with reference to, for example, FIGS. 1-2. At this point the property list may be refreshed with new and/or additional data and properties. This refreshing of the property list may be performed continuously or periodically, and may be a background process to allow use of the property list while the refreshing thereof occurs.

After display of the property list, a property may be selected in order to cause display of a property view as explained above with reference to FIGS. 3-10. The processing for a property view is also explained in greater detail below. While the property view is displayed, the process checks to see if an instruction to return to the property list view is received. If so, the processing returns to the display of the property list. Otherwise, the processing checks to see if a new property list is available, and if so, the new property list is selected and processed as discussed above. As can be appreciated, the checking for a new property list may be performed as a background process while a user is working with either the current property list or a particular property in a property view.

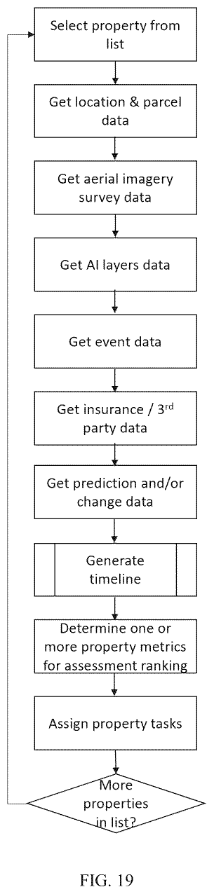

FIG. 19 is an algorithmic flow chart for collecting and ranking property list data according to exemplary aspects of the present disclosure. As illustrated in FIG. 19, a property list is selected and corresponding location and parcel data is obtained. The location and parcel data may be, for example, geocoding data that converts address data to latitude and longitude data.

After collecting the location and parcel data, aerial imagery survey data is obtained. Then AI layer data that, for example, reflects roofing conditions, vegetation overhang, etc. is obtained. The AI layer data may be generated in real-time as the previously discussed data is obtained, and the AI layers may be updated periodically as new data becomes available.

Event, insurance, and 3^{rd}-party data is also obtained. As discussed above, event data includes, for example, natural disaster data such as hurricane data, flood data, earthquake data, and the like. Event data may also include fire data and damage due to manmade events, such as terrorist attacks. Insurance data includes site valuations and inspections, and 3^{rd} party data includes repair estimates.

Once all of the data has been gathered, predictive data of future conditions of the property may be generated. As can be appreciated, the prediction data may predict improvements, deteriorations, and/or changes in the property and its structures.

Next, the timeline for the property view is generated as will be described below in greater detail. Property metrics, such as roof conditions, damage costs, risk estimates are determined in order to perform an assessment ranking. Any outstanding tasks are also assigned before determining whether additional properties are to be assessed. If so, the process is carried out again for the additional property.

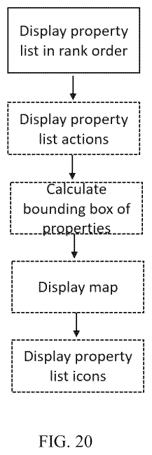

FIG. 20 is an algorithmic flow chart of display of a property list, such as in FIGS. 1-2, according to exemplary aspects of the present disclosure. The property list is displayed in rank order according to, for example, assessment rank (e.g., good insurance risk, fair insurance risk, poor insurance risk, etc.). Optionally, property list actions may be displayed for any action that needs to be taken, and to provide the ability to assign the action. The bounding box of the properties is also calculated and a corresponding map or aerial image is displayed. Property icons indicating, damage, condition, etc. may also be displayed.

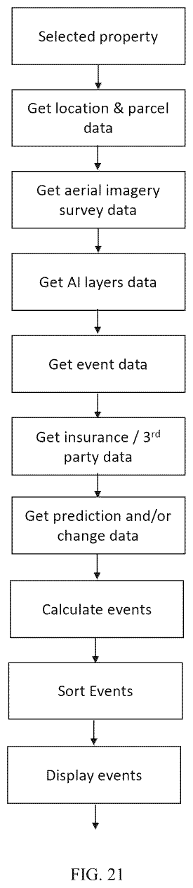

FIG. 21 is an algorithmic flow chart of generating the timeline displayed in a property view according to exemplary aspects of the present disclosure. The process of FIG. 21 begins with selection of a property, followed by acquisition of location and parcel data, and aerial imagery and survey data which have been described above. The AI layers for the property are then generated, and insurance, 3^{rd}-party data, and prediction or change data is obtained. Events, such as those already described, are calculated and sorted and displayed in chronological order as illustrated in the property views of FIGS. 3-10, for example. As can be appreciated, the timeline generation may be iterative and may be performed continually or periodically to account for new or updated data, such as the real-time data that may be obtained during in-flight processing as discussed above.

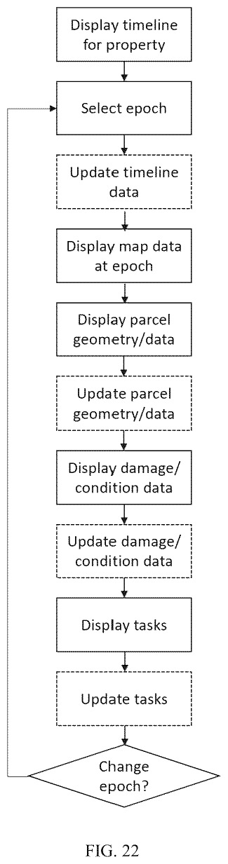

FIG. 22 is an algorithmic flow chart of displaying a property view, for example any one of FIGS. 3-10, according to exemplary aspects of the present disclosure. As illustrated in FIG. 22, the timeline is displayed for the property. Then an epoch, e.g., a subset of the timeline or an entry on the timeline is selected. Optionally, timeline data may be updated as described above. Then the map data corresponding to the epoch is displayed, e.g., an aerial image corresponding to the epoch. The geometry of the property, i.e., parcel, is displayed along with corresponding data. Optionally, the property geometry and/or data may be updated based on new/changed information. Any damage to the property may also be displayed along with the condition, e.g., the condition score, of the property. Any tasks that are outstanding may also be displayed and then updated as they are completed. This process can then be repeated for each epoch on the timeline.

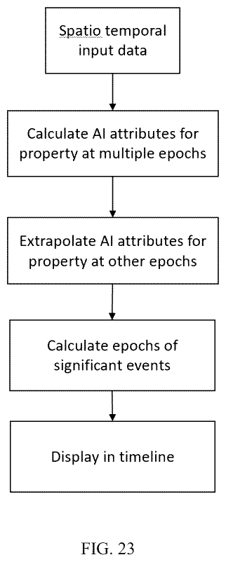

FIG. 23 is an algorithmic flow chart of a process for generating predictive events. For example, spatiotemporal data is used to generate predictive events, such as aerial imagery and/or digital surface model (DSM) data from multiple dates may be used. This data is used to determine AI attributes for multiple epochs, for example, for each of the multiple dates. Then the AI attributes are extrapolated to determine trends for other epochs, and the epochs, or dates, of significant events are computed and displayed in the time line. For example, current and past roof conditions may be used to calculate the date, or epoch, at which roof repair will be needed.

Observations occur on particular dates and may provide direct evidence of an event-the presence of construction materials, or a tarpaulin, or visible damage on the roof. Many events can be inferred between dates. This may include construction that is not observed but must have taken place in order for a house to change its structural shape from one date to the next. Events may be acute, occurring in a relatively fixed window. Other temporal information may include trends, such as sinusoidal variation with seasonality, or slow degradation of roof quality over time. Sequences are also highly relevant-construction events follow specific patterns as foundations are laid, walls go up, the roof is installed, and landscaping is performed. Because the measurements are relatively sparse in time (annual to several months), interpolation may be used to generate data for the intervening time between measurements. For example, a leaf-off winter only measurement of tree canopy may still have an accurate “summer extent” calculated if the seasonal relationship is modelled mathematically and statistically. With a large data set, it is possible to learn typical sequences, timings, and durations between events from data using machine learning techniques. This includes the typical time between a new roof, and a degraded roof that requires replacement. By learning from historical sequences and durations, models can be built which extrapolate into the future, providing a forward predictive capability. This may be embodied as a point prediction (years remaining until roof failure), or an equation (rate of tree growth, spread in roof ponding, or reduction in roof condition summary score). It may also be used to make retrospective prediction (roof age, even if observational data is not available prior to the current roof's presence). This can be performed in a post hoc manner, by using machine learning on imagery or other data sources to infer presence of events on an observation date, or numerical quantities associated with an observation date. However, this method may subject to noisy individual measurements (one observation may be impacted by lighting, occlusion, camera settings). Another way to perform this interpolation and extrapolation is to directly use raw observational data (such as images) in a machine learning model that accepts multiple images as inputs and produces an estimation of either when an event might occur, what event might occur next, or the rate of change of some quantity.

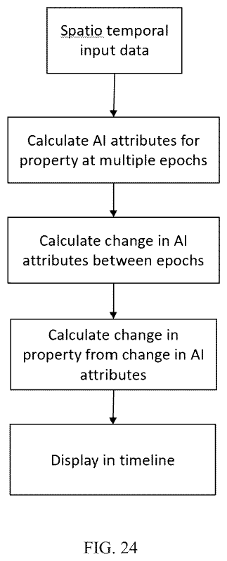

FIG. 24 is an algorithmic flowchart for determining inferred events according to exemplary aspects of the present disclosure. As in the case of predictive events discussed above with reference to FIG. 23, spatiotemporal data are received in order to calculate AI attributes for each epoch encompassed by the spatiotemporal data. Then changes in the AI attributes between epochs, or dates, are computed, and a change in the property is determined based on the changes in the AI attributes. For example, a change in the AI attributes indicating an improvement in roof condition may be used to determine, i.e., infer, that the roof of the property has been replaced during a particular epoch. This inference is then displayed on the timeline of the property.

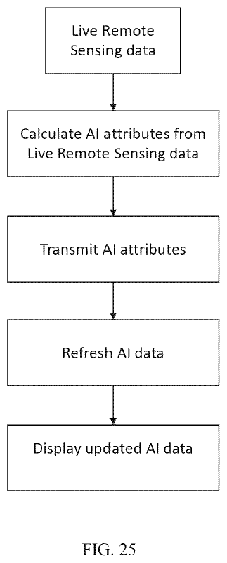

Next, in-flight processing according to exemplary aspects of the present disclosure is described with reference to the algorithmic flowchart of FIG. 25. In-flight processing leverages live, or real-time, remote sensing data to provide real-time data on property views. For example, live remote sensing data is gathered in order to compute update AI attributes therefrom. The attributes are transmitted to the system, or assessment tool, in order to refresh the current AI data and to update the displayed AI data. The live remote sensing data can be any of aerial imagery and/or LIDAR data or derived data, such as AI attributes and layers transmitted to the ground from aircraft, satellites, or other vantage points. In order to achieve this, some or all of the image processing and AI analysis may be performed in flight. Such in-flight processing may result in the latest imagery and data being available more rapidly than would be the case with offline processing.

As can be appreciated, the transmission of the data in FIG. 25 may be accomplished wirelessly using any known wireless communication method, and may be received via a remote server connection or directly. Line of sight communication methods are also possible without departing from the scope of the present disclosure.

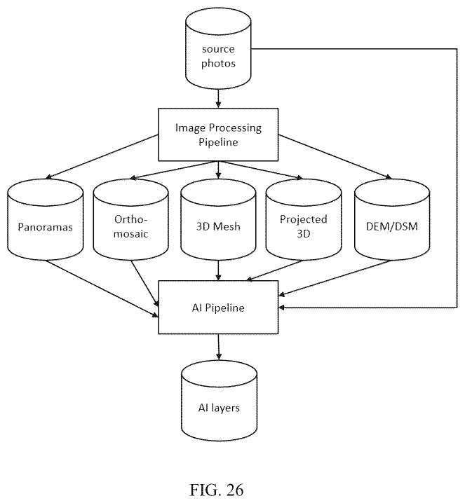

FIG. 26 is an example of processing aerial imagery according to exemplary aspects of the present disclosure. In FIG. 26, source photos are processed by the image processing pipeline to create panoramas, ortho-mosaics, 3D textured mesh, projected 3D images, and DEM/DSM products. The AI pipeline processes a subset of these image products or the source images to generate features (AI layers that may be vector or raster or a combination of both).

In addition to the aerial image based data, the AI pipeline may use any of historical data related to weather or climate events for the survey region; data related to properties in the survey region such as boundary information such as parcel boundary information, insurance information, information related to building materials (in particular data related to flammability, durability, weather resistance, impact resistance, or other suitable rating), planning and construction data such as timeline information, and any other related information; 3D data such as digital elevation (DEM) or DSM data; and historical data related to wildfires, floods, hurricanes, earthquakes, and other events.

The materials that compose a structure on the property may also be taken into account. For example, fire related properties of the construction materials, impact strength, moisture resistance, etc., may be considered. These material properties may be estimated, at least to some extent, through image analysis of the imagery of the property. For example, they may be determined from multiple views of the property and/or from multiple parts of the electromagnetic spectrum. Similar material analysis may be carried out for vegetation and natural features on the property in order to assess whether and/or how much risk they pose to the structures on the property.

In addition, multi-spectral satellite data, including but not limited to Infrared imaging, and information related to accessibility of property, for example distance to nearest arterial road, may also be considered.

In one aspect, the exemplary assessment tool uses overhead imagery to detect object types on the ground including, but not limited to vegetation, buildings, water bodies (e.g., swimming pools), power poles, junk and wreckage, decking, roads, cars, tires, etc. This may be achieved using semantic segmentation, where regions associated with different object types can be determined within the imagery. The generated output may be referred to as feature layers (or features), where each feature layer defines the geometry corresponding to a particular object. As can be appreciated, all of this data may be stored in the aerial imagery database or may be accessible from another source.

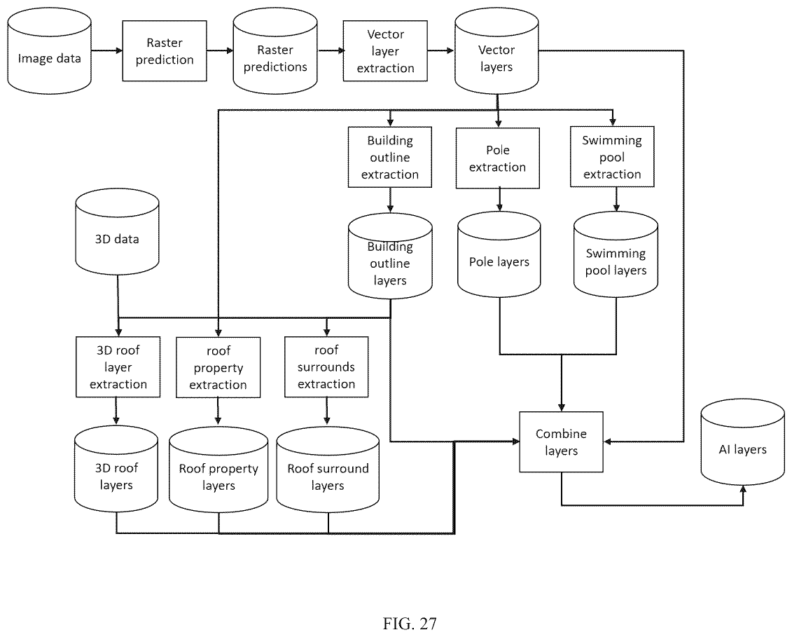

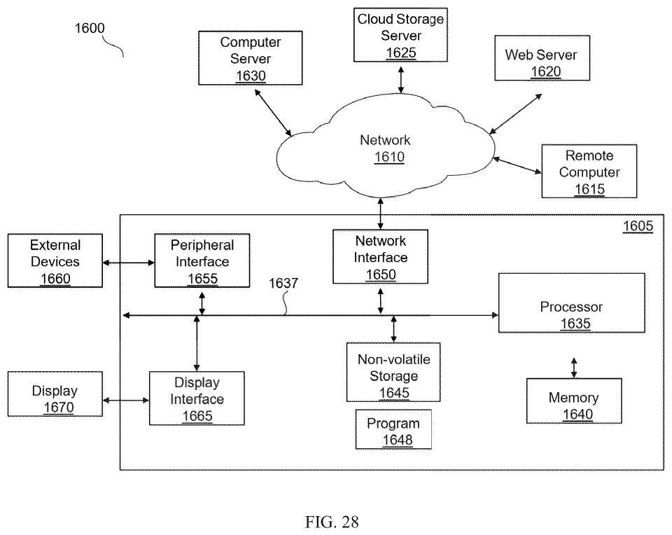

FIG. 27 is an example processing flow for machine learning feature classification according to exemplary aspects of the present disclosure. The processing pipeline inputs images and 3D data and generates various features and metrics in vector and raster format through multiple processing stages. For example, it generates and combines many vector layers of features. The 3D data may be DEM, 3D mesh for example from a 3D textured mesh, or DSM.

The system may determine property risk/condition based on future or past events according to exemplary aspects of the present disclosure. For example, an interactive system may allow risk assessment related metrics to be requested for a specific property. The risks may be from events such as fires, floods, hurricanes, earthquakes, and other potentially catastrophic events. Data from the aerial imagery database and elsewhere is obtained to generate the metrics, such as condition scores, risk scores, etc. The property may be requested based on one or more inputs such as an address or street address; a geographical location, for example defined by a latitude and longitude or a geocode; a property ID; and/or any other information that may be used to identify one or more locations in the property or associated with the property boundary.

In one exemplary aspect, building outlines may be used for the requested property location. In exemplary aspects, vector or raster machine learning is used to determine building outlines generated from the aerial imagery. Property outlines may also be input from construction plans, council planning data, and/or other sources.

Geometric regions, or zones, around the property building outlines at one or more distances are then generated based upon the above-described information. For example, regions of 0 to 5 ft, 0 to 10 ft, 0 to 30 ft, 0 to 100 ft and 0 to 300 ft may be generated. However, the generated regions may be defined based on other information such as local regulations, or the specific requirements of a user such as an insurance underwriter. Such requirements may be an optional input to the interactive system.

FIG. 28 is a schematic drawing of a processing system according to exemplary aspects of the present disclosure. FIG. 28 may provide an exemplary platform for implementation of the software and/or methods according to the present disclosure. Referring to FIG. 28, a networked system 1600 may include, but is not limited to, computer 1605, network 1610, remote computer 1615, web server 1620, cloud storage server 1625 and computer server 1630.

Additional details of computer 1605 are also shown in FIG. 28. The functional blocks illustrated within computer 1605 are provided only to establish exemplary functionality and are not intended to be exhaustive. And while details are not provided for remote computer 1615, web server 1620, cloud storage server 1625 and computer server 1630, these other computers and devices may include similar functionality to that shown for computer 1605.

Computer 1605 may be a personal computer (PC), a desktop computer, laptop computer, tablet computer, netbook computer, a personal digital assistant (PDA), a smart phone, or any other programmable electronic device capable of communicating with other devices on network 1610.

Computer 1605 may include processor 1635, bus 1637, memory 1640, non-volatile storage 1645, network interface 1650, peripheral interface 1655 and display interface 1665. Each of these functions may be implemented, in some embodiments, as individual electronic subsystems (integrated circuit chip or combination of chips and associated devices), or, in other embodiments, some combination of functions may be implemented on a single chip (sometimes called a system on chip or SoC).

Processor 1635 may be one or more single or multi-chip microprocessors, such as those designed and/or manufactured by Intel Corporation, Advanced Micro Devices, Inc. (AMD), Arm Holdings (Arm), Apple Computer, etc. Examples of microprocessors include Celeron, Pentium, Core i3, Core i5 and Core i7 from Intel Corporation; Opteron, Phenom, Athlon, Turion and Ryzen from AMD; and Cortex-A, Cortex-R and Cortex-M from Arm. Processors are considered processing circuitry or circuitry as they include transistors and other circuitry therein.

Bus 1637 may be a proprietary or industry standard high-speed parallel or serial peripheral interconnect bus, such as ISA, PCI, PCI Express (PCI-e), AGP, and the like.

Memory 1640 and non-volatile storage 1645 may be computer-readable storage media. Memory 1640 may include any suitable volatile storage devices such as Dynamic Random Access Memory (DRAM) and Static Random Access Memory (SRAM). Non-volatile storage 1645 may include one or more of the following: flexible disk, hard disk, solid-state drive (SSD), read-only memory (ROM), erasable programmable read-only memory (EPROM or Flash), compact disc (CD or CD-ROM), digital versatile disk (DVD) and memory card or stick.

Program 1648 may be a collection of machine readable instructions and/or data that is stored in non-volatile storage 1645 and is used to create, manage and control certain software functions that are discussed in detail elsewhere in the present disclosure and illustrated in the drawings. In some embodiments, memory 1640 may be considerably faster than non-volatile storage 1645. In such embodiments, program 1648 may be transferred from non-volatile storage 1645 to memory 1640 prior to execution by processor 1635.

Computer 1605 may be capable of communicating and interacting with other computers via network 1610 through network interface 1650. Network 1610 may be, for example, a local area network (LAN), a wide area network (WAN) such as the Internet, or a combination of the two, and may include wired, wireless, or fiber optic connections. In general, network 1610 can be any combination of connections and protocols that support communications between two or more computers and related devices.

Peripheral interface 1655 may allow for input and output of data with other devices that may be connected locally with computer 1605. For example, peripheral interface 1655 may provide a connection to external devices 1660. External devices 1660 may include devices such as a keyboard, a mouse, a keypad, a touch screen, and/or other suitable input devices. External devices 1660 may also include portable computer-readable storage media such as, for example, thumb drives, portable optical or magnetic disks, and memory cards. Software and data used to practice embodiments of the present disclosure, for example, program 1648, may be stored on such portable computer-readable storage media. In such embodiments, software may be loaded onto non-volatile storage 1645 or, alternatively, directly into memory 1640 via peripheral interface 1655. Peripheral interface 1655 may use an industry standard connection, such as RS-232 or Universal Serial Bus (USB), to connect with external devices 1660.

Display interface 1665 may connect computer 1605 to display 1670. Display 1670 may be used, in some embodiments, to present a command line or graphical user interface to a user of computer 1605. Display interface 1665 may connect to display 1670 using one or more proprietary or industry standard connections, such as VGA, DVI, DisplayPort and HDMI.

As described above, network interface 1650, provides for communications with other computing and storage systems or devices external to computer 1605. Software programs and data discussed herein may be downloaded from, for example, remote computer 1615, web server 1620, cloud storage server 1625 and computer server 1630 to non-volatile storage 1645 through network interface 1650 and network 1610. Furthermore, the systems and methods described in this disclosure may be executed by one or more computers connected to computer 1605 through network interface 1650 and network 1610. For example, in some embodiments the systems and methods described in this disclosure may be executed by remote computer 1615, computer server 1630, or a combination of the interconnected computers on network 1610. Data, datasets and/or databases employed in embodiments of the systems and methods described in this disclosure may be stored and or downloaded from remote computer 1615, web server 1620, cloud storage server 1625 and computer server 1630.

As can be appreciated, the present disclosure may be embodied as a system, a method, and/or a computer program product. The computer program product may include a computer readable storage medium on which computer readable program instructions are recorded that may cause one or more processors to carry out aspects of the embodiment.

The computer readable storage medium may be a tangible device that can store instructions for use by an instruction execution device (processor). The computer readable storage medium may be, for example, but is not limited to, an electronic storage device, a magnetic storage device, an optical storage device, an electromagnetic storage device, a semiconductor storage device, or any appropriate combination of these devices. A non-exhaustive list of more specific examples of the computer readable storage medium includes each of the following (and appropriate combinations): flexible disk, hard disk, solid-state drive (SSD), random access memory (RAM), read-only memory (ROM), erasable programmable read-only memory (EPROM or Flash), static random access memory (SRAM), compact disc (CD or CD-ROM), digital versatile disk (DVD) and memory card or stick. A computer readable storage medium, as used in this disclosure, is not to be construed as being transitory signals per se, such as radio waves or other freely propagating electromagnetic waves, electromagnetic waves propagating through a waveguide or other transmission media (e.g., light pulses passing through a fiber-optic cable), or electrical signals transmitted through a wire.

Computer readable program instructions described in this disclosure can be downloaded to an appropriate computing or processing device from a computer readable storage medium or to an external computer or external storage device via a global network (i.e., the Internet), a local area network, a wide area network and/or a wireless network. The network may include copper transmission wires, optical communication fibers, wireless transmission, routers, firewalls, switches, gateway computers and/or edge servers. A network adapter card or network interface in each computing or processing device may receive computer readable program instructions from the network and forward the computer readable program instructions for storage in a computer readable storage medium within the computing or processing device.

Computer readable program instructions for carrying out operations of the present disclosure may include machine language instructions and/or microcode, which may be compiled or interpreted from source code written in any combination of one or more programming languages, including assembly language, Basic, Fortran, Java, Python, R, C, C++, C# or similar programming languages. The computer readable program instructions may execute entirely on a user's personal computer, notebook computer, tablet, or smartphone, entirely on a remote computer or computer server, or any combination of these computing devices. The remote computer or computer server may be connected to the user's device or devices through a computer network, including a local area network or a wide area network, or a global network (i.e., the Internet). In some embodiments, electronic circuitry including, for example, programmable logic circuitry, field-programmable gate arrays (FPGA), or programmable logic arrays (PLA) may execute the computer readable program instructions by using information from the computer readable program instructions to configure or customize the electronic circuitry, in order to perform aspects of the present disclosure.

Aspects of the present disclosure are described herein with reference to flow diagrams and block diagrams of methods, apparatus (systems), and computer program products according to embodiments of the disclosure. It will be understood by those skilled in the art that each block of the flow diagrams and block diagrams, and combinations of blocks in the flow diagrams and block diagrams, can be implemented by computer readable program instructions.

The computer readable program instructions that may implement the systems and methods described in this disclosure may be provided to one or more processors (and/or one or more cores within a processor) of a general purpose computer, special purpose computer, or other programmable apparatus to produce a machine, such that the instructions, which execute via the processor of the computer or other programmable apparatus, create a system for implementing the functions specified in the flow diagrams and block diagrams in the present disclosure. These computer readable program instructions may also be stored in a computer readable storage medium that can direct a computer, a programmable apparatus, and/or other devices to function in a particular manner, such that the computer readable storage medium having stored instructions is an article of manufacture including instructions which implement aspects of the functions specified in the flow diagrams and block diagrams in the present disclosure.

The computer readable program instructions may also be loaded onto a computer, other programmable apparatus, or other device to cause a series of operational steps to be performed on the computer, other programmable apparatus or other device to produce a computer implemented process, such that the instructions which execute on the computer, other programmable apparatus, or other device implement the functions specified in the flow diagrams and block diagrams in the present disclosure.

Obviously, numerous modifications and variations of the present disclosure are possible in light of the above teachings. It is therefore to be understood that within the scope of the appended claims, the disclosure may be practiced otherwise than as specifically described herein.

1. A property assessment system, comprising:
circuitry configured to
obtain predetermined data for one or more properties;
obtain at least one of a map or an image of the one or more properties;
generate assessments for the one or more properties based on the predetermined data;
rank the one or more properties based on the assessments;
generate a list of the one or more properties based on the rank; and
display the list of the one or more properties in conjunction with the map or image of the one or more properties.

2. The property assessment system of claim 1, wherein the assessments of the one or more properties include an indication of a condition of at least a part of the one or more properties.

3. The property assessment system of claim 2, wherein the part of the one or more properties includes a property roof.

4. The property assessment system of claim 1, wherein the circuitry is further configured to
receive selection of a property of the one or more properties;
display property information corresponding to the property selected in conjunction with an image of the property; and
display a timeline of events pertaining to the property selected.

5. The property assessment system of claim 4, wherein the timeline includes at least one predictive event pertaining to the property selected, the predictive event being determined through extrapolation of past and current events on the timeline of the property selected.

6. The property assessment system of claim 4, wherein the circuitry is further configured to display indications of property damage, property condition, and property boundaries on the image of the property.

7. The property assessment system of claim 6, wherein the indications of property damage, property condition, and property boundaries are generated using artificial intelligence (AI) analysis of the predetermined data.

8. The property assessment system of claim 4, wherein the circuitry is further configured to
determine, based on analysis of data from events on the timeline, a status change in at least a portion of the property; and
infer an event and a time of the event based on the change in the status change.

9. The property assessment system of claim 8, wherein the status change indicates an improvement to a condition of the portion of the property, and the event inferred is a repair of the portion of the property.

10. The property assessment system of claim 1, wherein the predetermined data includes property location, property imagery, and property records.

11. The property assessment system of claim 1, wherein the circuitry is further configured to
receive real-time data from a remote sensor as part of the predetermined data; and
update the assessments based on the real-time data.

12. The property assessment system of claim 11, wherein the real-time data includes aerial imagery, lidar data, or both.

13. The property assessment system of claim 1, wherein the circuitry is further configured to generate descriptions for the one or more properties based on the predetermined data.

14. The property assessment system of claim 13, wherein the circuitry generates the descriptions using artificial intelligence.

15. The property assessment system of claim 4, wherein the predetermined data includes on-site data provided from a site visit to the property selected.

16. The property assessment system of claim 15, wherein the circuitry is configured to display a marker in a region of the property pertaining to the on-site data on the image of the property.

17. The property assessment system of claim 16, wherein the marker is interactive, and selection of the marker causes the circuitry to display the on-site information.

18. The property assessment system of claim 17, wherein the on-site information is displayed as a pop-up window overlay and includes buttons to assign an associated task or reject the on-site information.

19. A property assessment method performed by circuitry of a property assessment system, the method comprising:
obtaining predetermined data for one or more properties;
obtaining at least one of a map or an image of the one or more properties;
generating assessments for the one or more properties based on the predetermined data;
ranking the one or more properties based on the assessments;
generating a list of the one or more properties based on the rank; and
displaying the list of the one or more properties in conjunction with the map or image of the one or more properties.

20. A non-transitory computer-readable medium encoded with computer-readable instructions that, when executed by processing circuitry, cause the processing circuitry to perform a method comprising:
obtaining predetermined data for one or more properties;
obtaining at least one of a map or an image of the one or more properties;
generating assessments for the one or more properties based on the predetermined data;
ranking the one or more properties based on the assessments;
generating a list of the one or more properties based on the rank; and
displaying the list of the one or more properties in conjunction with the map or image of the one or more properties.
